(19) United States
(12) Patent Application Publication
(10) Pub. No.: US 2015/0012263 A1
(43) Pub. Date: Jan. 8, 2015

(54) SYSTEM AND METHOD FOR SEMANTIC ANALYSIS OF CANDIDATE INFORMATION TO DETERMINE COMPATIBILITY

(71) Applicant: DW Associates, LLC, Austin, TX (US)

(72) Inventors: Manu Rehani, Beaverton, OR (US); Warren L. Wolf, Austin, TX (US)

(21) Appl. No.: 14/495,294

(22) Filed: Sep. 24, 2014

Related U.S. Application Data
(63) Continuation-in-part of application No. 13/706,044, filed on Dec. 5, 2012.
Application No. 13/706,044 is a continuation-in-part of application No. 13/923,164, filed on Jun. 20, 2013.
Application No. 13/923,164 is a continuation-in-part of application No. 13/706,044, filed on Dec. 5, 2012.
(60) Provisional application No. 61/885,415, filed on Oct. 1, 2013.
(60) Provisional application No. 61/885,418, filed on Oct. 1, 2013.
(60) Provisional application No. 61/567,746, filed on Dec. 7, 2011.
(60) Provisional application No. 61/662,577, filed on Jun. 21, 2012.

(51) Int. Cl. G06F 17/27; G06Q 10/10

(52) U.S. Cl. CPC G06F 17/2785; G06Q 10/1053
USPC 704/9

(57) ABSTRACT

A computer includes a taxonomy, mapping grammatical patterns to qualities. A scanner on the computer can scan content to identify phrases that correspond to the grammatical patterns in the taxonomy. The computer can then calculate percentages of occurrences for the grammatical patterns, and also for combinations of grammatical patterns. The calculated percentages of occurrences can then be output.

### RELATED APPLICATION DATA

This application claims the benefit of U.S. Provisional Patent Application Ser. No. 61/885,415, titled “SYSTEM AND METHOD FOR SEMANTIC ANALYSIS OF CANDIDATE INFORMATION TO FIND COMPATIBILITY WITH A JOB”, filed Oct. 1, 2013, and U.S. Provisional Patent Application Ser. No. 61/885,418, titled “SYSTEM AND METHOD FOR SEMANTIC ANALYSIS OF CANDIDATE INFORMATION TO FIND COMPATIBILITY WITH A COMPANY CULTURE”, filed Oct. 1, 2013, both of which are incorporated herein by reference for all purposes.

This application is also a continuation-in-part of U.S. patent application Ser. No. 13/706,044, titled “METHODS AND SYSTEMS FOR TEAM SELECTION AND HIRING BY ANALYZING TEXT”, filed Dec. 5, 2012, now pending, which claims the benefit of U.S. Provisional Patent Application Ser. No. 61/567,746, titled “METHODS AND SYSTEMS FOR TEAM SELECTION AND HIRING BY ANALYZING TEXT”, filed Dec. 7, 2011, both of which are incorporated herein by reference for all purposes.

This application is also a continuation-in-part of U.S. patent application Ser. No. 13/923,164, titled “RÉSUMÉ SCREENING”, filed Jun. 20, 2013, now pending, which claims the benefit of U.S. Provisional Patent Application Ser. No. 61/662,577, titled “RÉSUMÉ SCREENING”, filed Jun. 21, 2012, and is a continuation-in-part of U.S. patent application Ser. No. 13/706,044, titled “METHODS AND SYSTEMS FOR TEAM SELECTION AND HIRING BY ANALYZING TEXT”, filed Dec. 5, 2012, now pending, which claims the benefit of U.S. Provisional Patent Application Ser. No. 61/567,746, titled “METHODS AND SYSTEMS FOR TEAM SELECTION AND HIRING BY ANALYZING TEXT”, filed Dec. 7, 2011, all of which are hereby incorporated by reference for all purposes.

### FIELD OF THE INVENTION

This invention pertains to semantic analysis, and more particularly to analyzing content to determine if a candidate is compatible with a job or a corporate culture.

### BACKGROUND OF THE INVENTION

In a hiring process, candidates generally present themselves to a potential employee through résumés. Additionally, these days additional information about the candidate can be found in their public online activity. Further, as the hiring process continues, additional information is available in the form of interviews, e-mail exchanges, questionnaires, etc.

Recruiters can use this information to develop an assessment of the candidate. The recruiter generally forms an assessment based on many factors, including his or her own experience, understanding of the job opening or corporate culture, reading between the lines of what the candidate is presenting, etc. Additionally, the recruiter may use his or her instinct to decide whether to recommend hiring a candidate or not.

Some aspects of these assessments are quantitative, like education level, specific degree in a specific discipline, years of experience, etc. Other aspects are qualitative like the candidate's ability to be creative, work in teams, be forceful or be courteous, etc.

The existing approach to measure, assess, and match the qualitative aspects of a candidate and a job involve: a) interviews in which people representing the job opening ask questions and evaluate the responses, b) self-assessment questionnaires in which the candidate is asked to comment upon his or her own qualitative aspects, and c) feedback from references who have worked with the candidate in the past.

The problem with the current approach is that the current approach is time consuming and does not scale up to considering large number of candidates at the same time. Moreover, assessments made by someone representing the job, the candidate himself, or a reference will not be consistent from one person to another or over time.

A need remains for a way to address these and other problems associated with the prior art.

### SUMMARY OF THE INVENTION

In an embodiment of the invention, a computer can store a taxonomy. A scanner can scan content to identify phrases that correspond to grammatical patterns in the taxonomy. The computer can then calculate percentages of occurrences, for both individual grammatical patterns and combinations of grammatical patterns. The calculated percentages can then be output.

In another embodiment of the invention, the calculated percentages can be compared to calculated percentages for another source content, such as a job description or a corporate culture. The comparison can be used to determine how close a fit the content is to the source content.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a computer system to determine how well a content compares to a source content, according to an embodiment of the invention.

FIG. 2 shows an example of the taxonomy of FIG. 1.

FIG. 3 shows the computer system of FIG. 1 comparing the content with source contents.

FIG. 4 shows the ranker of FIG. 1 ranking various contents.

FIG. 5 shows the scanner of FIG. 1 including a proximity calculator.

FIGS. 6A-6B show a flowchart of a procedure to determine how well a content compares to a source content using the computer system of FIG. 1.

### DETAILED DESCRIPTION OF THE PREFERRED EMBODIMENT

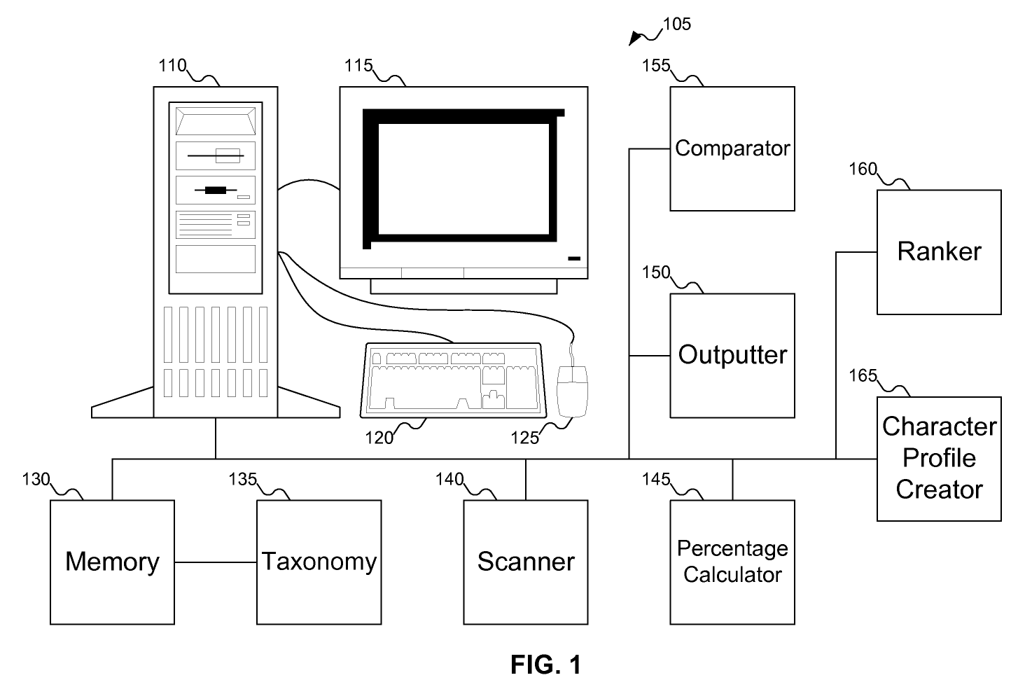

FIG. 1 shows a computer system to determine how well a content compares to a source content, according to an embodiment of the invention. FIG. 1 shows computer system 105, which is shown as including computer 110, monitor 115, keyboard 120, and mouse 125, Computer system 105 can also include other components not shown in FIG. 1: for example, other input/output devices, such as a printer. In addition, although FIG. 1 shows computer system 105 as including memory 130, FIG. 1 does not show other conventional internal components of computer system 105: for example, a central processing unit, memory, storage, etc. Although not shown in FIG. 1, a person skilled in the art will recognize that computer system 105 can interact with other computer systems either directly or over a network (also not shown in FIG. 1) of any type. Finally, although FIG. 1 shows computer system 105 as a conventional computer, a person skilled in the art will recognize that computer system 105 can be any type of computing device capable of providing the services attributed herein to machine 105, including, for example, a laptop computer, a personal digital assistant (PDA), or a cellular telephone.

Memory 130 can store taxonomy 135. Taxonomy 135 provides a mapping between grammatical patterns and qualities of language. This taxonomy provides a way to analyze content about a job candidate and determine whether the job candidate is a good fit, to whatever end is desired by the reviewer. For example, one embodiment of the invention can determine whether the job candidate is a good fit for a job, whereas another embodiment of the invention can determine whether the job candidate is a good fit for a corporate culture. Although FIG. 1 shows only one taxonomy, memory 130 can store any number of taxonomies, which can be applied to the same content or different content, as described below.

Computer system 105 can also include scanner 140, percentage calculator 145, and outputter 150. Scanner 140 can scan a provided content to identify phrases in the content that are grammatical patterns as determined by taxonomy 135. Percentage calculator 145 can then calculate the percentage of occurrences for each grammatical pattern, relative to all grammatical patterns identified in the content. Percentage calculator can also calculate the percentage of occurrences for each combination of grammatical patterns, relative to all combinations of grammatical patterns. These calculated percentages of occurrences provide a profile of the candidate, which can be compared with other content, as needed. Finally, outputter 150 can output the calculated percentages of occurrences, as the profile of the candidate, for other uses.

Additional components of computer system 105 can include comparator 155, ranker 160, and character profile creator 165. Comparator 155 can be used to compare the calculated percentages of occurrences for one content with calculated percentages of occurrences for a second content. In this manner, the system can determine if a job candidate is a good match for either the job description or the corporate culture. For example, the second content can be a description of the job. This content will have its own grammatical patterns, which can be identified against taxonomy 135 to calculate percentages of occurrences for the second content. By comparing the calculated percentages of occurrences in the content for the job candidate with the calculated percentages of occurrences in the content for the job description, the system can determine if the candidate is a good match for the job description. A person skilled in the art will recognize that the use of a job description as the second content is an arbitrary choice, and other content can be used to determine whether the candidate is a good match. Thus, the second content could be a description of the corporate culture instead.

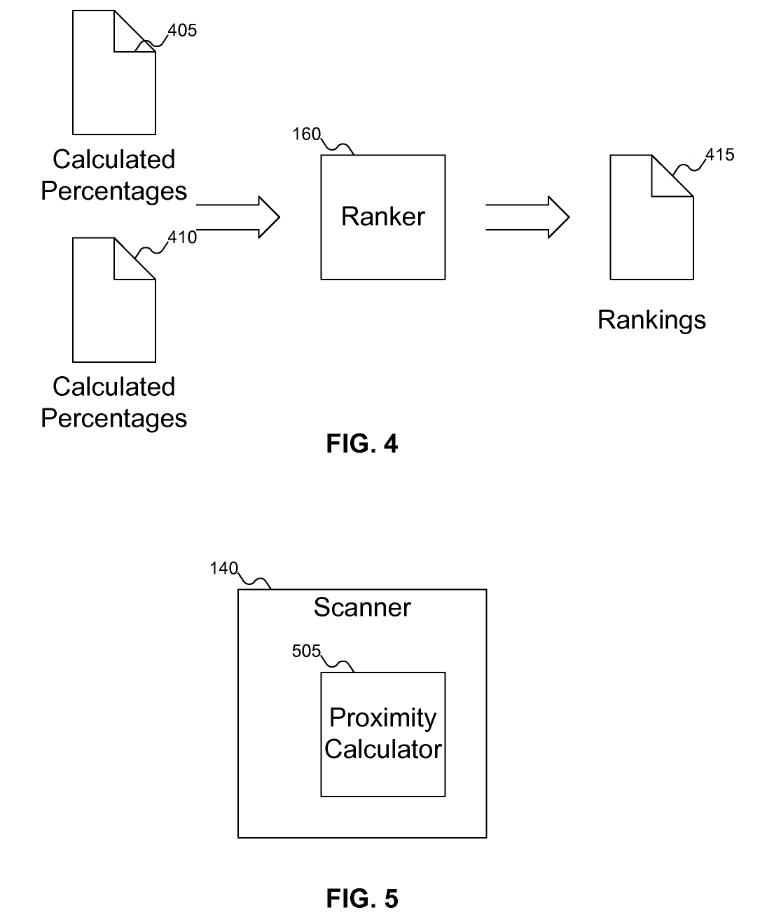

Ranker 160 can take calculated percentages for multiple candidates and rank them based on how closely they are a match to another content, such as a résumé or a corporate culture. Ranker 160 is discussed further with reference to FIG. 4 below.

Character profile creator 165 can take the calculated percentages of occurrences and create a character profile from the calculated percentages of occurrences. The character profile can then be stored, in either short-term or long-term storage in computer system 105, or elsewhere, for later comparison with other content, either for determining a good match or for ranking purposes.

The content that is analyzed according to embodiments of the invention can be any content. For example, the content can include a résumé by a job candidate, or written material from the job candidate, a transcript of an interview with the candidate, e-mails, or essays, among other possibilities.

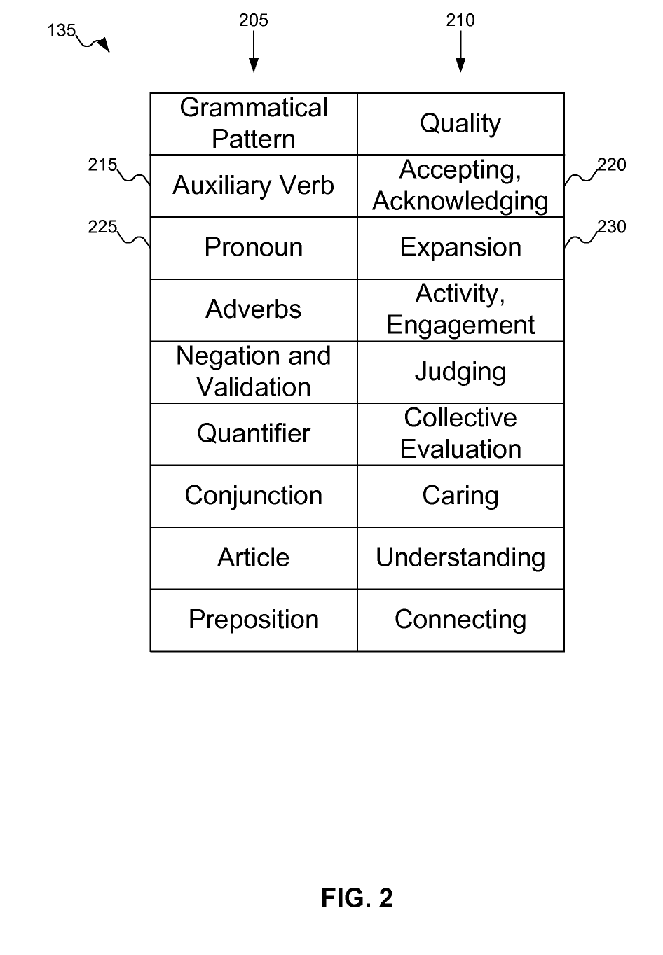

FIG. 2 shows an example of the taxonomy of FIG. 1. In FIG. 2, taxonomy 135 is shown as including grammatical patterns 205 and qualities 210. For each grammatical patterns, there is a corresponding quality. For example, the grammatical pattern auxiliary verb 215 has the quality of accepting or acknowledging 220, whereas the grammatical pattern pronoun 225 has the quality of expansion 230. A quality is a different way of behaving. For example, the quality of “expansion” means to identify with things, group with other people, and/or empathize with other people. Taxonomy 135 shown in FIG. 2 represents just one possible taxonomy, and a person skilled in the art will recognize that other taxonomies can be used instead of, or in combination with, taxonomy 135. A different taxonomy can have different grammatical patterns, and it could have different qualities.

Taxonomy 135 does not need to cover all possible words in the language (shown as English in the drawings, but embodiments of the invention are equally applicable to other languages as well). Parts of the language that do not fit a grammatical pattern can be ignored. That is, when calculating the percentages of occurrences, the percentages of occurrences are calculated only relative to all phrases that correspond to grammatical patterns. But it is possible to calculate percentages of occurrences relative to all text in the content. In that case, the sum of all calculated percentages of occurrences can be less than 100%.

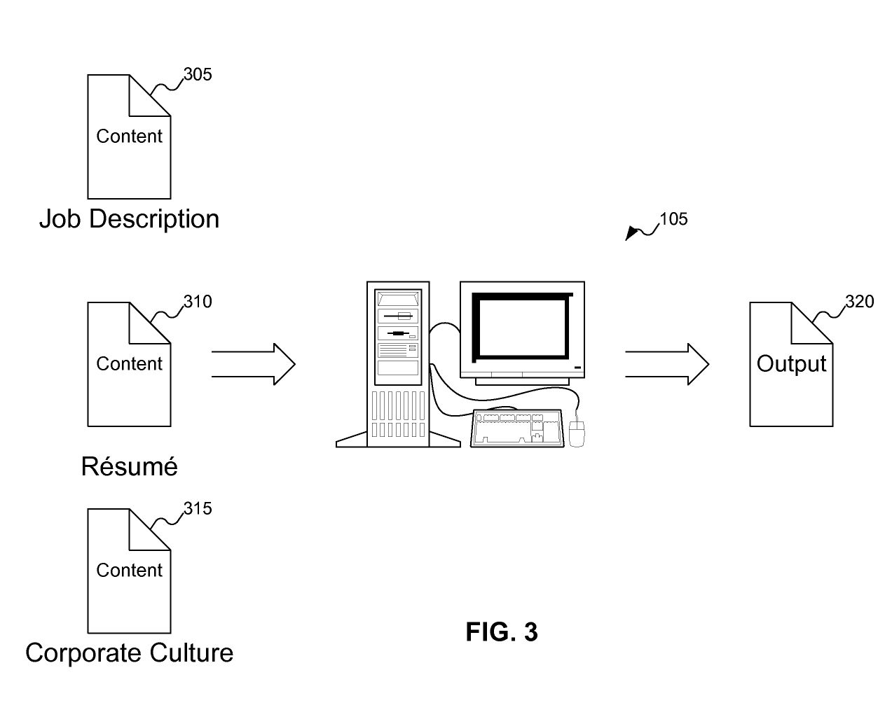

FIG. 3 shows the computer system of FIG. 1 comparing the content with source contents. In FIG. 3, computer system 105 is shown as receiving various contents, such as job description 305, résumé 310, and corporate culture 315. Computer system 105 can then compare these contents to determine their distance. For example, résumé 310 can be compared with job description 305 to determine whether the candidate is a good match for the job, or with corporate culture 315 to determine if the candidate is a good fit for the company's culture. The results of this comparison can then be output as output 320.

The distance between two source contents can be calculated in any desired manner. For example, distance can be measured as a count of the number of differences (between calculated percentages of occurrences for each quality) between the two source contents. Or, the distance can be adjusted by weighting different qualities differently, to reflect certain qualities that are considered more or less significant. Or, distance can be calculated by creating a vector for each source content, where each coordinate in the vector is a calculated percentage of occurrence for a quality. The distance between two source contents can then be calculated as the distance between the two vectors in N-dimensional space, again using any desired distance formula. Thus, the distance between two N-dimensional vectors can be measured using a Euclidean distance formula, or using taxicab distance, among other possibilities.

The comparison itself can be achieved by comparing the calculated percentages of occurrences for each grammatical pattern in the contents. For example, auxiliary verbs might constitute 2% of the résumé, but might constitute 4% of the job description. This difference can suggest that the candidate is less accepting than might be desired for the job. Other differences between the calculated percentages of occurrences in the contents can reflect other concerns that might exist with the candidate. The closer the candidate's content comes to matching the other content (in terms of calculated percentages), the better a match the candidate is for the job or corporate culture.

FIG. 4 shows the ranker of FIG. 1 ranking various contents. In FIG. 4, ranker 160 is shown receiving calculated percentages 405 and 410 of two different contents. These contents can be, for example, résumés from different job candidates. By comparing the individual calculated percentages of occurrences with content describing, for example, the job description or corporate culture, the “distance” between the candidate and the other content can be determined. This “distance” can then be compared with a “distance” for another candidate's content, and the “distances” can be ranked to reflect which candidate is considered a better fit for the job or corporate culture.

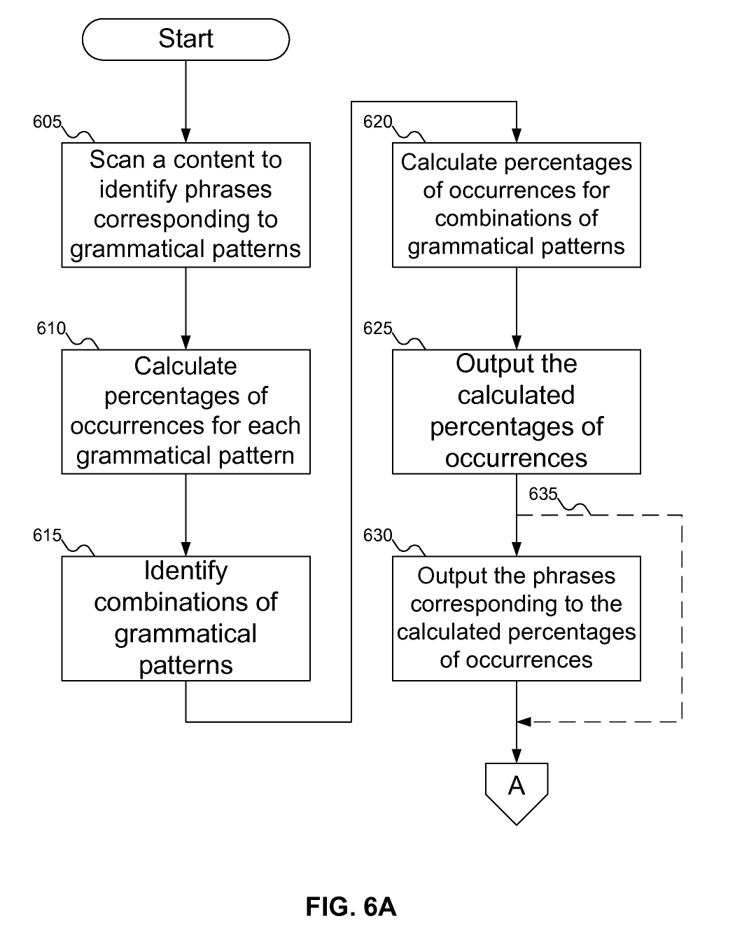

FIG. 5 shows the scanner of FIG. 1 including a proximity calculator. As discussed above, embodiments if the invention can calculate percentages of occurrences for combinations of grammatical patterns. Any combination of grammatical patterns is possible. To determine whether two grammatical patterns are close enough to represent a combination, proximity calculator 505 can be used. Proximity calculator 505 can determine whether two grammatical patterns are considered proximate for purposes of the embodiment of the claimed invention. Proximity can be determined in any desired manner. For example, proximity can be determined if the grammatical patterns are within a predetermined number of words of each other, or if the grammatical patterns are in the same sentence or paragraph, among other possibilities.

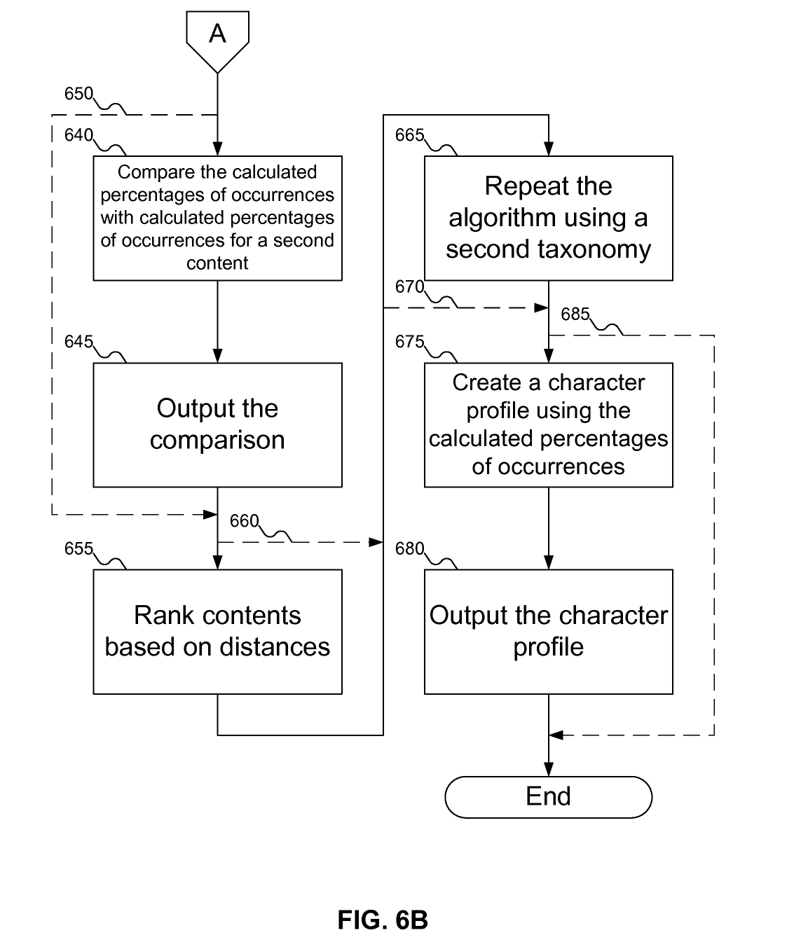

FIGS. 6A-6B show a flowchart of a procedure to determine how well a content compares to a source content using the computer system of FIG. 1. In FIG. 6A, at block 605, the system scans content to identify phrases that correspond to grammatical patterns. At block 610, the system calculates the percentage of occurrences for each grammatical pattern. At block 615, the system identifies combinations of grammatical patterns. At block 620, the system calculates percentages of occurrences for each combination of grammatical patterns. At block 625, the system can output the calculated percentages associated with each quality. The system can also output the phrases from the content that are associated with each quality. At block 630, the system can also output the phrases that correspond to the grammatical patterns. Block 630 can be omitted, as shown by dashed arrow 635.

At block 640 (FIG. 6B), the system can compare the calculated percentages with calculated percentages of occurrences for another content. At block 645, the results of the comparison can then be output. Blocks 640 and 645 can be omitted, as shown by dashed arrow 650.

At block 655, the system can rank contents based on distances from a base content (such as a job description or a corporate culture). Block 655 can be omitted, as shown by dashed arrow 660.

At block 665, the entire process (e.g., blocks 605-655, including or omitting all optional blocks, as desired) can be repeated additional times using other taxonomies, to provide alternative analyses for the content. Block 665 can be omitted, as shown by dashed arrow 670.

At block 675, a character profile can be created from the calculated percentages of occurrences, and at block 680 the character profile can be output. Blocks 675-680 can be omitted, as shown by dashed arrow 685.

The embodiments of the invention represented in the above flowcharts are merely exemplary, and are not intended to represent the only operative embodiment of the invention. Various blocks can be omitted, and the sequence of blocks can reordered, without affecting the employability of the embodiments of the invention. While the drawings might show specific ways in which blocks can be omitted or arranged, other arrangements are also possible and are intended to be covered by embodiments of the invention.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface (185), and input/output interface (185) ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface (185), modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

What is claimed is:

1. A system, comprising:
a computer (105);
a memory (130) in the computer (105);
a taxonomy (135) stored in the memory (130) of the computer (105);
a scanner (140) in the computer (105) to identify phrases in a content (305, 310, 315) that correspond to grammatical patterns (205) in the taxonomy (135);
a percentage calculator (145) to calculate percentages of occurrences for each grammatical pattern (205) in the scanned content (305, 310, 315) and to calculate a percentage of occurrences for each combination of grammatical patterns (205) in the scanned content (305, 310, 315) relative to all grammatical patterns (205) in the scanned content (305, 310, 315); and
an outputter (150) to output the percentages of occurrences for each grammatical pattern (205) in the scanned content (305, 310, 315) and the percentage of occurrences for each combination of grammatical patterns (205) in the scanned content (305, 310, 315) relative to all grammatical patterns (205) in the scanned content (305, 310, 315).

2. A system according to claim 1, wherein the outputter (150) is operative to output all phrases in the content (305, 310, 315) that correspond to at least one of the grammatical patterns (205).

3. A system according to claim 2, wherein:
the system further comprises a comparator (155) to compare the calculated percentage of occurrences for each grammatical pattern (205) in the content (305, 310, 315) with a second calculated percentage of occurrences for each grammatical pattern (205) in a second content (305, 310, 315); and
the outputter (150) is operative to output the comparison.

4. A system according to claim 3, wherein the content (305) is a job description and the second content (310) is a résumé.

5. A system according to claim 4, wherein:
the system further comprises a ranker (160) to rank a plurality of résumés based on distances between calculated percentages of occurrences for each grammatical pattern (205) in the job description and second calculated percentages of occurrences for each grammatical pattern (205) in each résumé in the plurality of résumés; and
the outputter (150) is operative to output the rankings (415) for the plurality of résumés.

6. A system according to claim 3, wherein the content (315) is a company culture and the second content (310) is a résumé.

7. A system according to claim 6, wherein:
the system further comprises a ranker (160) to rank a plurality of résumés based on distances between calculated percentages of occurrences for each grammatical pattern (205) in the company culture and second calculated percentages of occurrences for each grammatical pattern (205) in each résumé in the plurality of résumés; and
the outputter (150) is operative to output the rankings (415) for the plurality of résumés.

8. A system according to claim 1, wherein the content (305, 310, 315) can include written material drawn from a set including a résumé, a transcript of a conversation with a job candidate, an e-mail, and an essay.

9. A system according to claim 1, wherein:
the system can include a second taxonomy (135) stored in the memory (130) of the computer (105);
the scanner (140) is operative to phrases in the content (305, 310, 315) that correspond to second grammatical patterns (205) in the second taxonomy (135);
the percentage calculator (145) is operative to calculate second percentages of occurrences for each second grammatical pattern (205) in the scanned content (305, 310, 315) and to calculate a second percentage of occurrences for each second combination of second grammatical patterns (205) in the scanned content (305, 310, 315) relative to all second grammatical patterns (205) in the scanned content (305, 310, 315); and
the outputter (150) is operative to output the second percentages of occurrences for each second grammatical pattern (205) in the scanned content (305, 310, 315) and the second percentage of occurrences for each second combination of second grammatical patterns (205) in the scanned content (305, 310, 315) relative to all second grammatical patterns (205) in the scanned content (305, 310, 315).

10. A system according to claim 1, the scanner (140) includes a proximity calculator (505) to determine when the grammatical patterns (205) in an identified combination are proximate to each other.

11. A system according to claim 10, wherein the proximity calculator (505) can determine when the grammatical patterns (205) in an identified combination are proximate to each other based on a number of words between the grammatical patterns (205), whether the grammatical patterns (205) are in a common sentence, or whether the grammatical patterns (205) are in a common paragraph.

12. A system according to claim 1, further comprising a character profile creator (165) to create a character profile from the percentage of occurrences for each identified grammatical pattern (205) and for each identified combination of grammatical patterns (205) in the scanned content (305, 310, 315).

13. A method, comprising:
scanning (605) a content (305, 310, 315) to identify phrases in the content (305, 310, 315) that correspond to grammatical patterns (205) in a taxonomy (135);
calculating (610), on a machine, a percentage of occurrences for each grammatical pattern (205) in the scanned content (305, 310, 315) relative to all grammatical patterns (205) in the scanned content (305, 310, 315);
identifying (615) combinations of grammatical patterns (205) in the scanned content (305, 310, 315);
calculating (620) a percentage of occurrences for each identified combination of grammatical patterns (205) in the scanned content (305, 310, 315) relative to all grammatical patterns (205) in the scanned content (305, 310, 315); and
outputting (625) from the machine the percentage of occurrences for each identified grammatical pattern (205) and for each identified combination of grammatical patterns (205) in the scanned content (305, 310, 315).

14. A method according to claim 13, wherein outputting (625) from the machine the percentage of occurrences for each identified grammatical pattern (205) and for each identified combination of grammatical patterns (205) in the scanned content (305, 310, 315) includes outputting (630) from the machine all phrases in the content (305, 310, 315) that correspond to at least one of the grammatical patterns (205).

15. A method according to claim 13, further comprising:
comparing (640) the calculated percentage of occurrences for each grammatical pattern (205) in the content (305, 310, 315) with a second calculated percentage of occurrences for each grammatical pattern (205) in a second content (305, 310, 315); and
outputting (645) the comparison.

16. A method according to claim 15, wherein comparing (640) the calculated percentage of occurrences for each grammatical pattern (205) in the content (305, 310, 315) with a second calculated percentage of occurrences for each grammatical pattern (205) in a second content (305, 310, 315) includes comparing (640) the calculated percentage of occurrences for each grammatical pattern (205) in a job description (305) with the second calculated percentage of occurrences for each grammatical pattern (205) in a résumé (310).

17. A method according to claim 16, wherein:
comparing (640) the calculated percentage of occurrences for each grammatical pattern (205) in a job description (305) with the second calculated percentage of occurrences for each grammatical pattern (205) in a résumé (310) includes comparing (640) the calculated percentage of occurrences for each grammatical pattern (205) in the job description (305) with a plurality of second calculated percentages of occurrences for each grammatical pattern (205) in a plurality of résumés (310);
the method further comprises ranking (655) the plurality of résumés (310) based on distances between the calculated percentage of occurrences for each grammatical pattern (205) in the job description (305) and the second calculated percentage of occurrences for each grammatical pattern (205) in each résumé in the plurality of résumés (310); and
outputting (625) from the machine the rankings (415) for the plurality of résumés (310).

18. A method according to claim 15, wherein comparing (640) the calculated percentage of occurrences for each grammatical pattern (205) in the content (305, 310, 315) with a second calculated percentage of occurrences for each grammatical pattern (205) in a second content (305, 310, 315) includes comparing (640) the calculated percentage of occurrences for each grammatical pattern (205) in a company culture (315) with the second calculated percentage of occurrences for each grammatical pattern (205) in a résumé (310).

19. A method according to claim 18, wherein:
comparing (640) the calculated percentage of occurrences for each grammatical pattern (205) in a company culture (315) with the second calculated percentage of occurrences for each grammatical pattern (205) in a résumé (310) includes comparing (640) the calculated percentage of occurrences for each grammatical pattern (205) in the company culture (315) with a plurality of second calculated percentages of occurrences for each grammatical pattern (205) in a plurality of résumés (310);
the method further comprises ranking (655) the plurality of résumés (310) based on distances between the calculated percentage of occurrences for each grammatical pattern (205) in the company culture (3320) and the second calculated percentage of occurrences for each grammatical pattern (205) in each résumé in the plurality of résumés (310); and
outputting (625) from the machine the rankings (415) for the plurality of résumés (310).

20. A method according to claim 13, wherein scanning (605) a content (305, 310, 315) to identify phrases in the content (305, 310, 315) that correspond to grammatical patterns (205) includes scanning (605) the content (305, 310, 315) to identify the phrases in the content (305, 310, 315) that correspond to the grammatical patterns (205), where the content (305, 310, 315) can include written material drawn from a set including a résumé, a transcript of a conversation with a job candidate, an e-mail, and an essay.

21. A method according to claim 13, wherein:
the method further comprises:
scanning (605) the content (305, 310, 315) a second time to identify phrases in the content (305, 310, 315) that correspond to second grammatical patterns (205) in a second taxonomy (135);
calculating (610), on the machine, a second percentage of occurrences for each second grammatical pattern (205) in the second scanned content (305, 310, 315) relative to all second grammatical patterns (205) in the second scanned content (305, 310, 315);
identifying (615) second combinations of second grammatical patterns (205) in the second scanned content (305, 310, 315); and
calculating (620) a second percentage of occurrences for each identified second combination of second grammatical patterns (205) in the second scanned content (305, 310, 315) relative to all second grammatical patterns (205) in the second scanned content (305, 310, 315); and
outputting (625) from the machine the percentage of occurrences for each identified grammatical pattern (205) and for each identified combination of grammatical patterns (205) in the scanned content (305, 310, 315) includes outputting (625) from the machine the second percentage of occurrences for each identified second grammatical pattern (205) and for each identified second combination of second grammatical patterns (205) in the second scanned content (305, 310, 315).

22. A method according to claim 13, wherein identifying (615) combinations of grammatical patterns (205) in the scanned content (305, 310, 315) includes identifying (615) combinations of grammatical patterns (205) in the scanned content (305, 310, 315) based on a proximity of the grammatical patterns (205) in the identified combination.

23. A method according to claim 22, wherein identifying (615) combinations of grammatical patterns (205) in the scanned content (305, 310, 315) based on a proximity of the grammatical patterns (205) in the identified combination includes identifying (615) combinations of grammatical patterns (205) in the scanned content (305, 310, 315) based on the proximity of the grammatical patterns (205) in the identified combination, the proximity of the grammatical patterns (205) in the identified combination determined by measuring one of a number of words between the grammatical patterns (205), whether the grammatical patterns (205) are in a common sentence, or whether the grammatical patterns (205) are in a common paragraph.

24. A method according to claim 13, further comprising:
creating (675) a character profile from the percentage of occurrences for each identified grammatical pattern (205) and for each identified combination of grammatical patterns (205) in the scanned content (305, 310, 315); and
outputting (680) the character profile.

25. A tangible computer-readable medium storing non-transitory computer-executable instructions that, when executed by a processor, operate to perform the method according to claim 13.
